(19) United States
(12) Patent Application Publication
(10) Pub. No.: US 2005/0228572 A1
(43) Pub. Date: Oct. 13, 2005

(54) Catalyst temperature modelling during exotermic operation

(76) Inventor: Matthias Mansbart, Leonberg (DE)

Correspondence Address: KENYON & KENYON, ONE BROADWAY, NEW YORK, NY, 10004, US

(21) Appl. No.: 10/513,445

(22) PCT Filed: Jul. 25, 2003
(86) PCT No.: PCT/DE03/02511

§ 371 Date: Oct. 25, 2004

(30) Foreign Application Priority Data
Dec. 13, 2002 (DE) 102 58 278.5

(51) Int. Cl. B60T 7/12

(52) U.S. Cl. 701/108

(57) ABSTRACT

A method and a calculating device are for modeling the temperature of a catalytic converter in the exhaust gas of an internal combustion engine. In this context, the heat input into the catalytic converter based on exothermic reactions is taken into consideration. The method provides that a first correcting quantity delta_T1 and a second correcting quantity delta_T2 are formed, which each take into consideration a heat input into the catalytic converter based on exothermic reactions in the catalytic converter, delta_T1 being formed as a function of the ratio of the first fuel mass, combusted in the internal combustion engine simultaneously with an air mass, to the air mass, and delta_T2 being formed as a function of a heat input that results from an exothermic reaction of a second fuel mass, which was metered in for the regeneration of the catalytic converter in addition to the fuel proportion of the fuel/air mixture combusted in the internal combustion engine.

### FIELD OF THE INVENTION

The present invention relates to a method for calculating the temperature of a catalytic converter in the exhaust gas of an internal combustion engine. The method may include: forming a base value for the temperature of the catalytic converter; calculating a correcting quantity delta-T1 which takes into consideration the heat input into the catalytic converter based on exothermic reactions in the catalytic converter, and which is a function of the ratio of the first fuel mass combusted in the internal combustion engine simultaneously with an air mass and of the exhaust gas temperature; and filtering a value correlated to a catalytic converter temperature using low-pass filtering and forming a new value for the temperature of the catalytic converter, taking into consideration the base value and the result of the low-pass filtering.

The present invention also relates to a calculating device for calculating the temperature of a catalytic converter in the exhaust gas of an internal combustion engine which executes the aforementioned steps.

### BACKGROUND INFORMATION

In a method and a calculating device described in U.S. Pat. No. 4,656,829, the temperature of a catalytic converter in the exhaust gas stream of an internal combustion engine is calculated based on the air mass taken in by the internal combustion engine, and the fuel/air ratio of the mixture combusted in the internal combustion engine. In this context, contributions to temperature are used which have been empirically determined for stationary states of the internal combustion engine operation at certain values of the air mass throughput and the fuel/air ratio. The values determined for stationary conditions are submitted to a time delay filtering of the first order, which is based on the air mass flow through the internal combustion engine, and which represents the answer of the catalytic converter temperature to the transient operation states of the internal combustion engine.

In response to currently favored concepts for exhaust gas treatment systems of internal combustion engines, catalytic converters are used which work according to the storage principle and/or the regeneration principle. Thus, for example, in exhaust gas systems for internal combustion engines having direct gasoline injection, NOx storage catalysts are used. In the operation of internal combustion engines having excess air, comparatively high NOx emissions are created. A major portion of the nitrogen oxide emissions can be absorbed by an NOx storage catalyst. It is true that the absorption capability of storage catalysts is limited, so that these storage catalysts have to be regularly regenerated in order to become absorptive for nitrogen oxides again. Such a regeneration may take place, for example, by generating excess fuel in the exhaust gas of the internal combustion engine at certain ranges of the catalytic converter temperature.

In connection with the operation of Diesel internal combustion engines it is conventional in addition that one may install particulate filters in the exhaust gas in order to reduce the emission of such particles. Even these particulate filters have a limited absorptive capacity and also have to be regenerated regularly. This too can take place by generating fuel excess in the exhaust gas upstream of the particulate filter in connection with keeping to certain conditions for the particulate filter temperature.

Since the regeneration of both NOx storage catalysts and particulate filters takes place in a satisfactory manner only when certain conditions for the exhaust gas temperature apply, a knowledge that is as accurate as possible of the current exhaust gas temperature and the temperature of exhaust gas-guiding components is of great importance for the control of the internal combustion engine and the control of the aforementioned regeneration processes in connection with the operation of the internal combustion engine. Therefore, these temperatures have to be measured or modeled. It is also conventional that one may use oxidation catalysts for exhaust gas purification. Oxidation catalysts are operated either by lean engine operation or by additional air injection using air excess, in order to oxidize CO and HC. In oxidation catalysts, at almost every operating point, exothermic reactions by oxidation of uncombusted HC, NO, etc, are occurring.

In general, exhaust gas treatment systems require additional measures, at certain operating points, such as during operation having low air mass throughput, and thus comparatively low exhaust gas heat generation, in order to raise the exhaust gas temperature. Modern injection systems make possible fuel injection that occurs late. Under late injection, an injection is understood that, relative to the beginning of combustion, occurs so late that large portions of the injected fuel quantity is not combusted in the combustion chamber. The uncombusted parts of the injected fuel quantity are transported along with the exhaust gas into the oxidation catalyst and are there oxidized catalytically, which is able to lead to a clear increase in temperature if, in particular, the temperature conditions for the onset of the catalytic reaction are satisfied.

For the onset of the catalytic reaction, in particular, a minimum temperature must have been exceeded. On the other hand, because of exothermic reactions, quantities of heat may be liberated that are able to lead to overheating of the catalytic converter. It is therefore desirable to know the temperature of catalytic converters in general, and NOx storage catalysts, particulate filters and oxidation catalysts in particular, not only in stationary operation conditions and during transitions from a first stationary operating condition to a second stationary operating condition, but also to have knowledge about the catalytic converter temperature developing in the context of regeneration of a catalytic converter with the aid of exothermic reactions initiated in a controlled manner.

### SUMMARY

According to an example embodiment of the present invention, a method and a device for calculating the catalytic converter temperature may make possible the calculation of the catalytic converter temperature in normal operation without subsequent exothermic regeneration taking place and in operations having subsequent regeneration of the catalytic converter.

According to an example embodiment of the present invention, a method may provide that, for the calculation of delta_T, a first correcting quantity delta_T1 and a second correcting quantity delta_T2 are formed, delta_T1 is formed as a function of the ratio of the first fuel mass combusted in the internal combustion engine simultaneously with an air mass and delta_T2 is formed as a function of the base value for the exhaust gas temperature and a heat input into the exhaust gas which results from an exothermic reaction of at least one part of a second fuel mass, which was metered in for the regeneration of the catalytic converter in addition to the fuel proportion of the fuel/air mixture combusted in the internal combustion engine.

According to an example embodiment of the present invention, a calculating device may perform the aforementioned steps in the formation of first correcting quantity delta_T1 and second correcting quantity delta_T2.

An example embodiment of the present invention may permit taking into consideration the catalytic converter temperature or the particulate filter temperature during the control of the internal combustion engine in connection with a regeneration of the catalytic converter or the particulate filter. Thereby it may be prevented that the internal combustion engine, for example, at insufficient exhaust gas temperature is operated using fuel excess, in order to trigger a regeneration. At an exhaust gas temperature that is too low, the fuel excess may at least not completely react in the catalytic converter or the particulate filter, so that the desired temperature increase and regeneration does not occur. In addition, because of that, uncombusted hydrocarbons may also be emitted into the environment.

By contrast, if, in an exothermically occurring regeneration, a permitted maximum value for the temperature of the exhaust gas treatment system is exceeded, countermeasures are able to be triggered. For example, the exothermically occurring reaction may be completely stopped, or it may be interrupted, in order to be triggered anew after undershooting a critical temperature.

As a result, both undesired HC emissions and undesired high thermal loads of the exhaust gas treatment system may be avoided thereby. This may be achieved by a calculation on the basis of operating parameters, which are present in a control unit in any case. Therefore, one may do without a costly temperature sensor, which may be positioned such that it records the temperature at the location of a possible exothermic reaction, that is, in the catalytic converter itself.

It may be provided that the first correcting quantity delta_T1 is ascertained from a characteristics map, in which the influences ot the temperature-dependent specific heat capacity of the exhaust gas is taken into consideration.

First correcting quantity delta_T1 represents a measure for temperature contributions which, independently of regeneration measures, appear because of chemical reactions in the exhaust gas aftertreatment system. Definitive for these contributions may be the exhaust gas temperature and the oxygen concentration in the exhaust gas. It is therefore possible, directly as a function of the exhaust gas temperature upstream of the exhaust gas aftertreatment system and the oxygen concentration prevailing there, to ascertain a temperature increase delta_T1 from a characteristics map, since this increase of the exhaust gas temperature is independent of the exhaust gas flow. The influences of the exhaust gas temperature-independent specific heat capacity of the exhaust gas are able to be taken into consideration directly in the characteristics map. The exhaust gas temperature upstream of the exhaust gas aftertreatment system may be either measured or modeled. It may be provided to calculate the influence of exothermically occurring reactions in the exhaust gas aftertreatment system on the exhaust gas temperature or on the exhaust gas aftertreatment system.

Furthermore, it may be provided that the second correcting quantity delta_T2 is formed as a function of a value which is read out from a characteristics map for the catalytic converter activity as a function of the base value for the exhaust gas temperature.

This arrangement may take into consideration that the catalytic converter activity and therewith the extent of the heat generated in a catalytically triggered exothermically occurring reaction in the catalytic converter is a function of the temperature of the catalytic converter or the exhaust gas aftertreatment system. As a result, because of the taking into consideration of this influence, the accuracy of modeling the temperature may be increased.

It may also be provided that, as the catalytic converter temperature-correlated value, the sum is formed from the base value for the temperature of the catalytic converter, first correcting quantity delta_T1 and second correcting quantity delta_T2.

The low-pass filtering of this sum may describe well the actual temperature curve in the catalytic converter during an exothermic reaction.

It may also be provided that the heat input into the exhaust gas, which results from an exothermic reaction of at least a part of the second fuel mass, is formed by multiplication of this part of the second fuel mass by the specific calorific value of the fuel used.

Good results may be achieved if the heat input into the exhaust gas is formed in the manner described.

Furthermore, it may be provided that the part of the second fuel mass is ascertained by a minimum selection between the value of the second fuel mass and the result of a maximum selection between the value zero and the value of a difference of a fuel mass, which is able to be combusted stoichiometrically with the air mass enclosed for combustion in the internal combustion engine, and the first fuel mass actually taking part in the combustion.

This arrangement may take into consideration that the heat becoming liberated in an exothermic reaction in the catalytic converter is not only a function of a fuel mass that is available for such an exothermic reaction, but also of the oxygen quantity that is available in the exhaust gas. In addition, this arrangement may provide how the oxygen quantity that is available may be formed from operating parameters that are present in any case in the control unit of the internal combustion engine. In this manner, the heat becoming liberated in an exothermic reaction and the temperature rise connected with it may be accurately determined if the air quantity available for the reaction is not sufficient for utilizing the total second fuel mass available for the reaction. The control unit may in this case, for example, and beyond the already described aspects, take care that the second fuel mass is diminished in successive injections, in order to prevent liberation of HC emissions into the environment, or at least to lower them.

It may be provided that the low-pass filtering is a PT1 filtering, the time constant of which is a function of operating characteristic quantities of the internal combustion engine.

Using such a time constant that is a function of operating characteristic quantities of the internal combustion engine, good results, i.e., results corresponding to actual circumstances, may be achieved in the modeling of the exhaust gas temperature and/or the temperature of the exhaust gas aftertreatment system.

It may be provided that the time constant of the PT1 filtering is a function of the exhaust gas mass flow.

In addition, it may be provided that the time constant is a function of the reciprocal value of the exhaust gas mass flow and the quotient of specific heat capacities of the catalytic converter and the exhaust gas.

These quantities may bring about a response of the time constant which may lead to good results of the temperature modeling in the PT1 filtering.

Additional aspects are set forth in the following description with reference to the appended Figures.

The features indicated above and those yet to be clarified in the following are usable not only in each specified combination, but also in other combinations or by themselves.

Example embodiments of the present invention are illustrated in the drawings and are explained more fully in the following description.

### BRIEF DESCRIPTION OF THE DRAWINGS

FIG. 1 illustrates the technical environment in which an example embodiment of the present invention may show its effect.

FIG. 2 illustrates a linking of data present in a calculating device and sensor signals supplied to the calculating device to form input variables for the calculation of the temperature of the catalytic converter.

FIG. 3 illustrates a linkage of such input variables for calculating the temperature of the catalytic converter.

### DETAILED DESCRIPTION

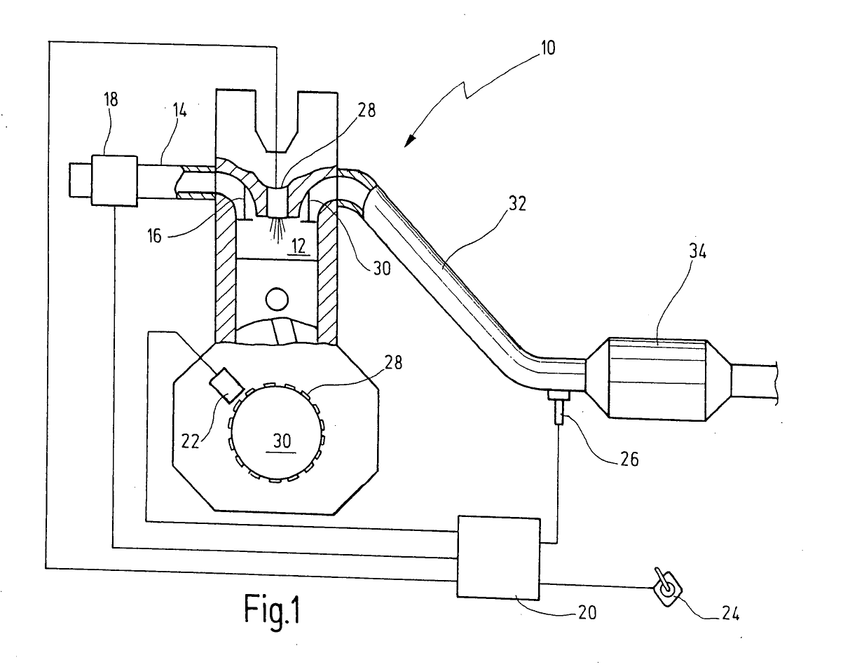

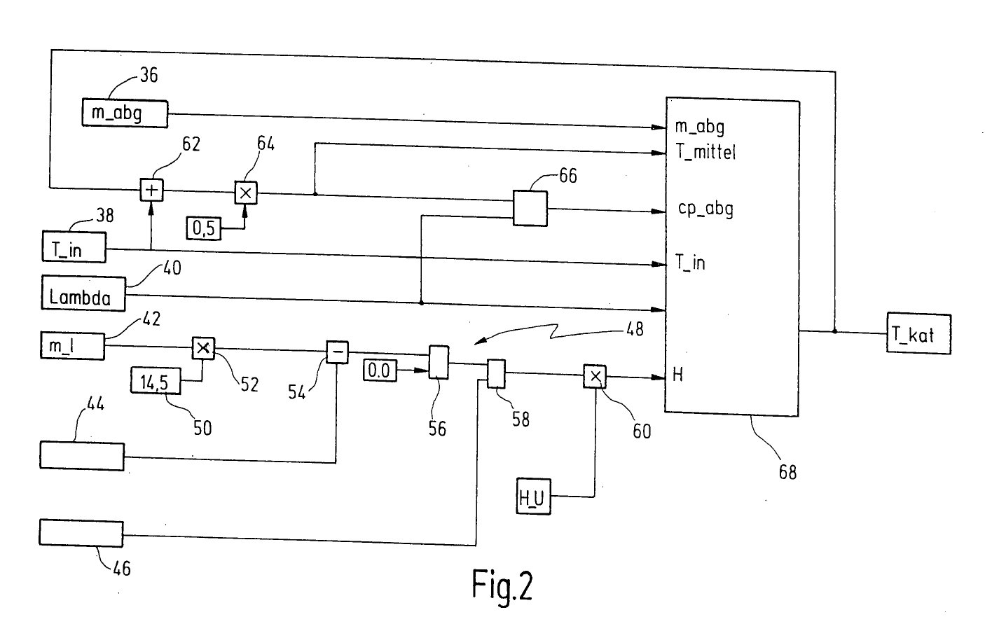

The number 10 in FIG. 1 denotes an internal combustion engine having a combustion chamber 12 in which a mixture of fuel and air is combusted. Combustion chamber 12 has air supplied to it via a vacuum line 14, the air supply being controlled by at least one intake valve 16. The mass of air taken in by internal combustion engine 10 is recorded by an air mass flow sensor 18, which passes on an air mass signal to calculating device 20, such as an electronic control unit. The signals of additional sensors are supplied to calculating device 20, of which FIG. 1 illustrates a rotary speed sensor 22, an accelerator sensor 24 and an exhaust gas sensor 26.

Signals of additional sensors, for example, concerning temperatures in the region of the internal combustion engine or concerning the transmission ratio of a post-connected torque converter, etc., may also be supplied to calculating device 20. Rotary speed sensor 22 illustrated in FIG. 1 may, for example, be an inductive sensor, which inductively scans ferromagnetic markings 28 on a pulse-generating wheel 30. Accelerator sensor 24 may have a potentiometer via which the angle of the accelerator, and thus the torque command of the driver is able to be recorded.

Exhaust gas sensor 26 may be an oxygen concentration sensor, as may extensively be used in today's motor vehicles. As may be conventional, oxygen concentration sensor 26 is not only able to supply a signal concerning the oxygen concentration in the exhaust gas, but from its signal data may also be retained concerning the temperature of exhaust gas sensor 26, and thus, concerning the temperature of the exhaust gas at the mounting location of exhaust gas sensor 26. For example, the internal resistance of a sensor ceramic that is able to conduct oxygen ions and/or the electrical resistance of an electrical exhaust gas probe heater, etc., may be used for the determination of temperature.

In addition to this, not only oxygen concentration sensors may come into consideration as exhaust gas sensor 26, but sensors sensitive to other exhaust gas components may also be used, such as NOx sensors, CO sensors and/or HC sensors, etc. The exhaust gas temperature and/or the catalytic converter inlet temperature may also be recorded by a separate temperature sensor, such as a thermocouple, and passed over to calculating device 20.

From the signals of the sensors mentioned, calculating device 20, while retrieving data stored in characteristic curves and/or characteristic maps, calculates signals for controlling actuators for controlling internal combustion engine 10. Thus, for example, calculating device 20 calculates a fuel metering signal, such as an injection pulse width, using which a fuel metering unit 28, such as a fuel injector, is controlled. In the representation in FIG. 1, fuel injector 28 is arranged such that the fuel is metered directly into combustion chamber 12 of internal combustion engine 10. This corresponds to direct fuel injection, as may be used both in Diesel internal combustion engines and Otto internal combustion engines. Example embodiments of the present invention are not limited to internal combustion engines having direct injection but may be able to be used in the case of Otto internal combustion engines having manifold injection. After a combustion of the fuel/air mixture enclosed in combustion chamber 12, which, depending on the working principle of internal combustion engine 10, may be triggered by self-ignition or by externally supplied ignition of the compressed mixture, the exhaust gases are conducted to a catalytic converter 34, via an exhaust valve and an exhaust ducting, such as a composite of exhaust gas manifold and exhaust pipes, in which undesired exhaust gas components such as CO, HC and NOx are catalytically oxidized, stored or reduced.

Catalytic converter 34 may be an oxidation catalyst, a reduction catalyst, a three-way catalyst or lambda-probe-equipped catalytic converter. In addition to that, it may be an NOx storage catalyst or a particulate filter. Catalytic converter 34 may therefore also be more generally designated as an exhaust gas aftertreatment device 34. In connection with an example embodiment of the present invention, it may be provided that exhaust gas aftertreatment device 34 may be able to be operated exothermically at least from time to time, the temperature change appearing based on the exothermic reaction of both the exhaust gas aftertreatment device 34 itself and of the exhaust gas flowing through exhaust gas aftertreatment device 34 being calculated, using a calculation model.

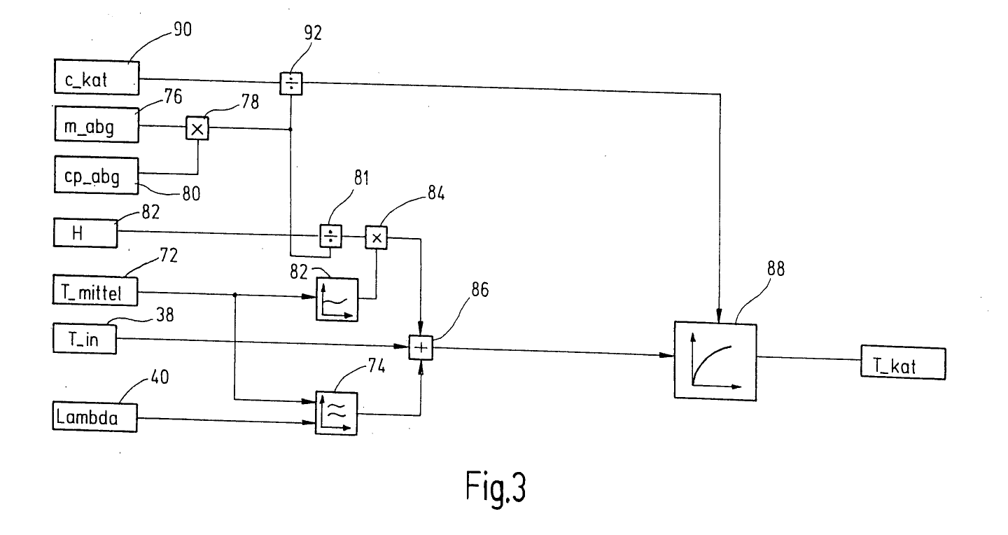

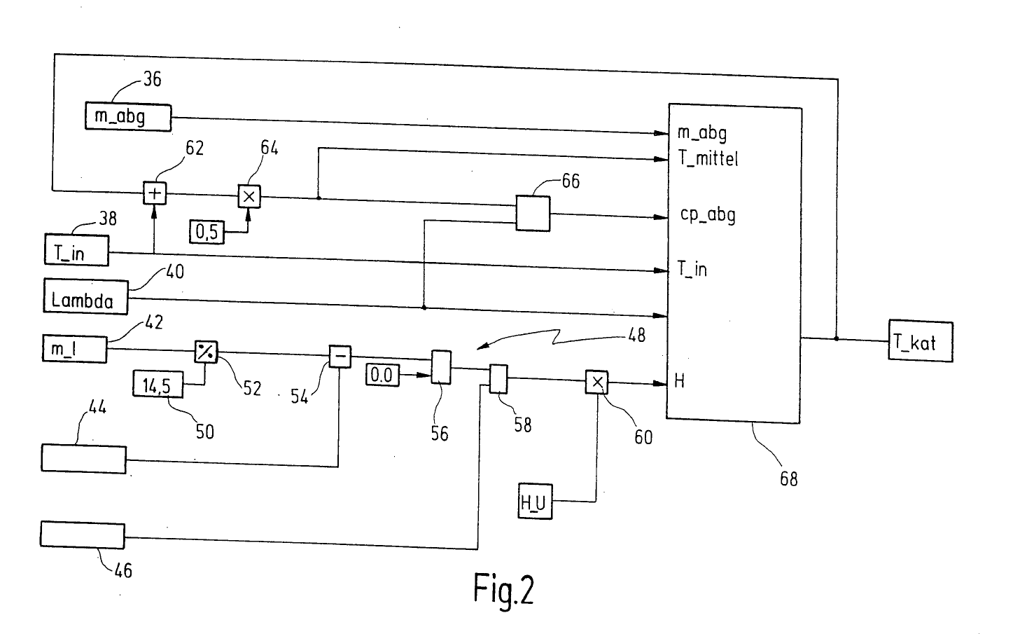

FIG. 2 illustrates how, within such calculating models, first of all input variables are formed for the calculation from data present in calculating device 20 and from the sensor signals passed over to calculating device 20.

Field 36 represents the exhaust gas mass flow, that is, the mass of exhaust gas emitted per unit of time from internal combustion engine 10. It is able to be calculated in control unit 20 from the fuel mass metered in via fuel injectors 12 and from the air mass sucked in via air mass flow sensor 18. The exhaust gas mass flow is also denoted below as m_abg. Field 38 designates the catalytic converter's inlet temperature T_in. At the start of internal combustion engine 10, T_in may first be a plausible base value, e.g., a fixed value for an average bypass temperature, or T_in may be obtained, as described above, by a separate sensor or by evaluation of the signal of exhaust gas sensor 26.

Field 40 represents the signal of exhaust gas sensor 26, in this case an oxygen concentration sensor, which supplies a measure for the lambda value, which tells whether the combustion in combustion chamber 12 took place having an air excess or a fuel excess. Field 42 represents the air mass m_1 sucked in per unit of time, as it is supplied by air mass flow sensor 18 to control unit 20. Field 44 corresponds to a first fuel mass (fuel mass_1) per unit of time, which is supplied to combustion chambers 12 by regular main injections for a combustion that is as complete as possible in combustion chamber 12. Field 46 represents a fuel mass_2 per unit of time, which is supplied to combustion chambers 12 by injections that take place late, and which reacts at least not completely with the air present in combustion chamber 12.

In branch 48, thermal energy H is calculated from the air mass, fuel mass_1 and fuel mass_2, which is able to be liberated during a subsequent reaction in exhaust gas aftertreatment device 34. First of all, an equal fuel mass is calculated, from the air mass in block 52, by division by the value 14.5 (block 50), which may be combusted stoichiometrically with the air mass. From this theoretical fuel mass, fuel mass_1 is subtracted in block 54. The value yielded by block 54, however, corresponds to that fuel mass which may be stoichiometrically combusted with the oxygen still remaining after the combustion of fuel mass_1. This value may be less than zero, equal to zero or greater than zero.

In block 56, the maximum of this value and the value zero is selected, so that the value given by block 56 is either equal to zero or greater than zero. This value indicates that fuel mass which, to the extent that it is available, is able to react exothermically with the still remaining residual oxygen in exhaust gas aftertreatment device 34.

In block 58 the minimum of this value and the value of fuel mass_2 is selected. The value thus obtained corresponds to that fuel mass which is effectively available in order to react exothermically with the remaining oxygen in exhaust gas aftertreatmnent device 34. This fuel mass is multiplied in block 60 by calorific value H_U of the type of fuel used, so that the product supplies the heat quantity H that is able to be liberated by exothermic reaction in exhaust gas aftertreatment device 34. In this context, it may make no difference whether the value H was calculated as an absolute heat quantity or as a heat quantity per unit of time.

As an additional input variable, another average catalytic converter temperature T_mittel is formed. For this, catalytic converter temperature T-kat, that is calculated by the model, is combined recursively in block 62 with the value of catalytic converter inlet temperature T_in from field 38, and in block 64 the result is submitted to the forming of an average. The average thus obtained represents the additional inlet variable T_mittel for the subsequent calculation of T_kat. In addition to that, the average catalytic converter temperature T_mittel is used together with the lambda value from field 40 for addressing a characteristics map 66 stored in control unit 20, which supplies the specific heat capacity cp_abg of the exhaust gas as a function of the input variables named. Block 68 stands in for the property of the real exhaust gas conversion device 34, under the influence of the named input variables m_abg, T_mittel, cp_abg, T_in, lambda and H to assume the temperature T_kat at the outlet of exhaust gas aftertreatment device 34.

In addition, rotary speed m of the internal combustion engine is still taken into consideration, so as particularly to normalize the sucked in air mass flow for individual combustion chamber charges.

In other words, in branch 48 the rate of heat flow is ascertained, which is supplied to exhaust gas aftertreatment device 34 by fuel mass_2 that did not combust in the combustion chamber. First, an equal fuel quantity is ascertained from the air mass flow via the stoichiometric ratio. From this equal fuel quantity, fuel mass_1 is subtracted. The resulting difference describes the fuel mass which may still maximally react with the residual oxygen in the exhaust gas. If the difference is less than or equal to zero, one may assume that no more oxygen is contained in the exhaust gas, and fuel mass flow_2 or fuel mass_2 may not react. However, if the difference is greater than zero, possibly a portion of, or the entire fuel mass flow_2 (fuelmass_2) is able to react.

FIG. 3 illustrates an example embodiment of the method for calculating the temperature of a catalytic converter from the input variables named above. First of all, making available the value T_in in field 38 corresponds to the step of forming a base value for the temperature of the catalytic converter. For the formation of a first correcting quantity delta_T1, the average temperature T_mittel, represented by field 72, and the lambda value, represented by field 40, are used to address a characteristics map 74, from which first correcting quantity delta_T1 may be read out as a function of the input variables named. First correcting quantity delta_T1 takes into consideration the chemical reactions, in exhaust gas aftertreatment device 34, that appear independently of regeneration measures. For these reactions, exhaust gas temperature and exhaust gas composition may be decisive. Accordingly, a temperature increase delta_T1 is directly ascertained from characteristics map 74 as a function of lambda and the temperature, since this temperature increase is independent of the exhaust gas flow. The influences of the temperature-dependent heat capacity of the exhaust gas are able to be taken into consideration in this context, directly in characteristics map 74.

To form correcting quantity delta_T2, first of all, exhaust gas mass m_abg in block 78, that is made available in field 76, is multiplied by the specific heat capacity cp_abg of the exhaust gas that is made available by block 80. The result represents a heat quantity corresponding to the temperature unit or a heat flow corresponding to the temperature unit. In other words, the result indicates that heat quantity which is required for achieving a temperature difference of one degree. In block 81, heat quantity H, made available by field 82, is divided by the value issued by block 78. The result represents the maximum energy flow that is able to be liberated by the catalytic reaction of late-injected fuel mass_2 with the oxygen still remaining in the combustion chamber after the combustion of fuel mass_1. Of this maximum quantity, a certain portion is actually liberated which is a function of the catalytic activity of exhaust gas aftertreatment device 34. This dependence is taken into consideration by the multiplication of the output of block 81 by the value of the catalytic activity in block 84 that is read out from a characteristics curve (block 82). In this context, block 82 is addressed by average catalytic converter temperature T_mittel from field 72, since the catalytic activity is temperature-dependent. The result of the combination in block 84 thus represents the value of second correcting quantity delta_T2, which describes a heat input into the exhaust gas, which results from an exothermic reaction of at least one part of a second fuel mass, which was metered for the regeneration of the catalytic converter additionally to the fuel proportion of the fuel/air mixture combusted in the internal combustion engine.

First correcting quantity delta_T1, second correcting quantity delta_T2 and the base value made available in field 38 for catalytic converter temperature T_in are combined additively in block 86, and in block 88 they are submitted to low-pass filtering, which may have a PT1 characteristic. In this context, the time constant of the low-pass filtering is a function of the reciprocal of exhaust gas mass flow m_abg and the quotient of specific heat capacities of the catalytic converter (c_kat), which is made available by field 90, and the exhaust gas. In this context, c_kat in block 92, which represents a division, is combined with exhaust gas mass m_abg and the heat capacity of exhaust gas cp_abg.

The temperature calculation presented takes into consideration that the reactions, and thus also the temperature increases take place on the inside of the catalytic converter or exhaust gas aftertreatment device 34. In simplified terms, however, in the model building presented here, first a corrected inlet temperature is ascertained, which is composed of catalytic converter inlet temperature T_in, temperature increase delta_T1 by normal, i.e., exothermic reactions taking place in the catalytic converter even without regeneration, and temperature increase delta_T2 by fuel which was metered in as fuel mass_2 especially for regeneration purposes. Based on the method of construction of the catalytic converter, it may, as a close approximation, be regarded as an ideal heat exchanger.

It follows from this that catalytic converter temperature T_kat and the exhaust gas temperature at the exit of catalytic converter 34 or exhaust gas aftertreatment device 34 may be regarded as identical at each point in time. This assumption leads to a differential equation which may mathematically be read off for a PT1 filtering having the variable time constant of the product of the reciprocal value of the exhaust gas mass flow and the quotient of specific heat capacities of the catalytic converter and the exhaust gas. For this reason, the current catalytic converter temperature at the outlet of catalytic converter 34 is able to be modeled by the presented PT1 filtering of the corrected inlet temperature.

1-10. (canceled)

11. A method for calculating a temperature of a catalytic converter in an exhaust gas of an internal combustion engine, comprising:
(a) forming a base value for the temperature of the catalytic converter;
(b) calculating a first correcting quantity and a second correcting quantity that take into consideration a heat input into the catalytic converter based on exothermic reactions in the catalytic converter, the first correcting quantity calculated as a function of a ratio of a first fuel mass combusted in the internal combustion engine simultaneously with an air mass to the air mass, of a temperature of the exhaust gas and of the base value, the second correcting quantity calculated as a function of the base value and a heat input into the exhaust gas that results from an exothermic reaction of at least part of a second fuel mass metered in for regeneration of the catalytic converted in addition to a fuel proportion of a fuel/air mixture combusted in the internal combustion engine;
(c) forming a value correlated with the temperature of the catalytic converter as a function of the base value and the first correcting value; and
(d) forming a value for the temperature of the catalytic converter by filtering the value correlated with the temperature of the catalytic converter by low-pass filtering.

12. The method according to claim 11, wherein the first correcting quantity is formed in the calculating step (b) from a characteristics map, which takes into account influences of a temperature-dependent specific heat capacity of the exhaust gas.

13. The method according to claim 11, wherein the second correcting quantity is formed in the calculating step (b) as a function of a value read out from a characteristics map for catalytic converter activity as a function of the base value.

14. The method according to claim 11, wherein the value correlated with the catalytic converter temperature is formed in the forming step (c) as a sum of the base value, the first correcting quantity and the second correcting quantity.

15. The method according to claim 11, further comprising forming a value of the heat input into the exhaust gas that results from an exothermic reaction of at least a part of the second fuel mass by multiplying the part of the second fuel mass by a specific calorific value of fuel used.

16. The method according to claim 15, further comprising determining the part of the second fuel mass by a minimum selection between a value of the second fuel mass and a result of a maximum selection between a value zero and a value of a difference of a fuel mass able to be combusted stoichiometrically with an air mass enclosed for combustion in the internal combustion engine and the first fuel mass actually taking part in the combustion.

17. The method according to claim 11, wherein the low-pass filtering includes a PT1 filtering having a time constant that is a function of operating parameters of the internal combustion engine.

18. The method according to claim 17, wherein the time constant of the PT1 filtering is a function of an exhaust gas mass flow.

19. The method according to claim 18, wherein the time constant of the PT1 filtering is a function of a reciprocal of the exhaust gas mass flow and a quotient of specific heat capacities of the catalytic converter and the exhaust gas.

20. A method for calculating a temperature of a catalytic converter in an exhaust gas of an internal combustion engine, comprising:
an arrangement configured to form a base value for the temperature of the catalytic converter;
an arrangement configured to calculate a first correcting quantity and a second correcting quantity that take into consideration a heat input into the catalytic converter based on exothermic reactions in the catalytic converter, the first correcting quantity calculated as a function of a ratio of a first fuel mass combusted in the internal combustion engine simultaneously with an air mass to the air mass, of a temperature of the exhaust gas and of the base value, the second correcting quantity calculated as a function of the base value and a heat input into the exhaust gas that results from an exothermic reaction of at least part of a second fuel mass metered in for regeneration of the catalytic converted in addition to a fuel proportion of a fuel/air mixture combusted in the internal combustion engine;
an arrangement configured to form a value correlated with the temperature of the catalytic converter as a function of the base value and the first correcting value; and
an arrangement configured to form a value for the temperature of the catalytic converter by filtering the value correlated with the temperature of the catalytic converter by low-pass filtering.

21. A device for calculating a temperature of a catalytic converter in an exhaust gas of an internal combustion engine, comprising:
means for forming a base value for the temperature of the catalytic converter;
means for calculating a first correcting quantity and a second correcting quantity that take into consideration a heat input into the catalytic converter based on exothermic reactions in the catalytic converter, the first correcting quantity calculated as a function of a ratio of a first fuel mass combusted in the internal combustion engine simultaneously with an air mass to the air mass, of a temperature of the exhaust gas and of the base value, the second correcting quantity calculated as a function of the base value and a heat input into the exhaust gas that results from an exothermic reaction of at least part of a second fuel mass metered in for regeneration of the catalytic converted in addition to a fuel proportion of a fuel/air mixture combusted in the internal combustion engine;
means for forming a value correlated with the temperature of the catalytic converter as a function of the base value and the first correcting value; and
means for forming a value for the temperature of the catalytic converter by filtering the value correlated with the temperature of the catalytic converter by low-pass filtering.
